(19) United States
(12) Patent Application Publication
(10) Pub. No.: US 2019/0286593 A1
(43) Pub. Date: Sep. 19, 2019

(54) Audio Signal Transmission

(71) Applicant: Bose Corporation, Framingham, MA (US)

(72) Inventor: Xin Li, Wellesley, MA (US)

(73) Assignee: Bose Corporation, Framingham, MA (US)

(21) Appl. No.: 16/355,783

(22) Filed: Mar. 17, 2019

Related U.S. Application Data
(60) Provisional application No. 62/643,906, filed on Mar. 16, 2018.

(51) Int. Cl. G06F 13/38; H01R 13/26; H01R 13/652; H04R 1/10

(52) U.S. Cl. CPC G06F 13/382; H01R 13/26; G06F 2213/0042; H04R 1/1033; H04R 2420/09; H01R 13/652

(57) ABSTRACT

A method, system, and cable for transferring analog audio signals from an analog audio source to an audio sink, where the audio sink has a USB-C connector. The cable is coupled to the audio source and to the USB-C connector of the audio sink. The cable is constructed and arranged to carry audio signals. The audio sink detects the coupling of the cable to the USB-C connector of the audio sink. Responsive to this detecting, the audio sink receives analog audio signals from the audio source over the cable.

### CROSS-REFERENCE TO RELATED APPLICATION

This application claims priority of Provisional Patent Application Ser. No. 62/643,906, filed on Mar. 16, 2018, the entire disclosure of which is incorporated herein by reference for all purposes.

### BACKGROUND

This disclosure relates to transmission of analog audio signals from an audio source to an audio sink.

Not all headphones and other audio sink devices carry an analog audio input jack. Such devices are often configured to receive audio signals wirelessly. However, not all audio sources are able to wirelessly transmit audio signals.

### SUMMARY

All examples and features mentioned below can be combined in any technically possible way.

In one aspect, a method of transferring analog audio signals from an analog audio source to an audio sink, where the audio sink has a USB-C connector, includes coupling a cable to the audio source and to the USB-C connector of the audio sink, where the cable is constructed and arranged to carry audio signals, detecting, by the audio sink, the coupling of the cable to the USB-C connector of the audio sink, and responsive to the detecting, receiving, by the audio sink from the audio source over the cable, analog audio signals.

Examples may include one of the following features, or any combination thereof. The cable may comprise a plug that is constructed and arranged to couple to an audio output jack of the audio source, and a USB-C plug that is constructed and arranged to couple to a USB-C receptacle of the audio sink. The plug that is constructed and arranged to couple to an audio output jack of the audio source may be a 3.5 mm audio plug.

In another aspect, a system for receiving, by an audio sink, analog audio signals from an analog audio source, includes a cable that is constructed and arranged to carry analog audio signals, and that comprises a first connector that is constructed and arranged to be coupled to an audio output of the audio source, a USB-C connector that is constructed and arranged to be coupled to a USB-C audio input of the audio sink, and circuitry of the audio sink that is adapted to detect when the cable is coupled to the USB-C connector. The audio sink is configured, in response, to cause the reception of analog audio signals by the audio sink from the audio source over the cable.

Examples may include one of the following features, or any combination thereof. The cable may comprise a plug that is constructed and arranged to couple to an audio output jack of the audio source, and a USB-C plug that is constructed and arranged to couple to a USB-C receptacle of the audio sink. The plug that is constructed and arranged to couple to an audio output jack of the audio source may be a 3.5 mm audio plug.

Examples may include one of the following features, or any combination thereof. The cable may be configured to short two connector pins of the second USB-C connector to ground. The two connector pins of the second USB-C connector that are shorted to ground may comprise CC1 and CC2 pins. The shorting of the two connector pins of the second USB-C connector to ground may be accomplished by the circuitry of the audio sink. When the two connector pins of the second USB-C connector are shorted to ground, a D+/R pin of the second USB-C connector may be switched to analog R. When the two connector pins of the second USB-C connector are shorted to ground, a D−/L pin of the second USB-C connector may be switched to analog L. When the two connector pins of the second USB-C connector are shorted to ground, an SBU pin of the second USB-C connector may be switched to ground.

In another aspect, a cable includes a first connector that is constructed and arranged to be coupled to an audio output jack of an analog audio source, a USB-C connector that is constructed and arranged to be coupled to a USB-C input connector of an audio sink, and a set of conductors that are electrically connected to both the audio plug connector and the USB-C connector, and are constructed and arranged to carry audio signals.

Examples may include one of the following features, or any combination thereof. The first connector may comprise a plug that is constructed and arranged to couple to an audio output jack of the audio source, and the USB-C connector may comprise a USB-C plug that is constructed and arranged to couple to a USB-C receptacle of the audio sink. The plug that is constructed and arranged to couple to an audio output jack of the audio source may comprise a 3.5 mm audio plug.

### BRIEF DESCRIPTION OF THE DRAWINGS

FIG. 1 is schematic diagram of a system for conducting analog audio signals from a source to a sink via a cable.

FIG. 2A schematically illustrates an audio plug and a USB-C plug of a cable for the system of FIG. 1.

FIG. 2B schematically illustrates a control scheme for the system of FIG. 1.

FIG. 3 is similar to FIG. 2A, but for a source that can also supply power to recharge the battery of the sink.

FIG. 4 is a schematic depiction of a cable.

### DETAILED DESCRIPTION

Some wireless headphones, and other wireless audio sink devices such as portable speakers, no longer include an analog audio input connector (e.g., a standard 3.5 mm plug) and are designed to receive audio data wirelessly. However, some audio sources do not have wireless audio data transmission capabilities and so cannot be wirelessly coupled to these audio sinks. Some audio sources only have a hard-wired audio output (e.g., an audio output jack), including, without limitation, the entertainment systems of many commercial airliners, and older audio systems. Some wireless audio sink devices include a multiple-pin connector, such as USB-C connector. In order for these wireless audio sinks to receive audio signals from audio sources that are not enabled for wireless transmission, a cable can be provided. The cable can have connectors that can be coupled to the output connector of the audio source and a USB-C connector of the sink. The audio sink can be enabled to automatically detect when the cable has been connected to it, so that it is enabled to receive its audio signals over the cable rather than from another source (e.g., a second, wireless source). For illustrative purposes, the audio sink devices described herein may be one or more audio devices, such as a portable speaker, a speaker that is part of a home theater system, and headphones. Unless specified otherwise, the term headphone, as used in this document, includes various types of personal acoustic devices such as over-the-ear and in-ear headsets, earphones, earbuds, hearing aids, head-worn (e.g., glasses), shoulder-worn, or body-worn acoustic devices, or other wireless-enabled acoustic devices.

Elements of the figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram, the steps may be performed by one element or a plurality of elements. The steps may be performed together, or at different times. The elements that perform the activities may be physically the same or proximate one another, or may be physically separate. One element may perform the actions of more than one block. Audio signals may be encoded or not, and may be transmitted in either digital or analog form. Conventional audio signal processing equipment and operations are in some cases omitted from the drawing.

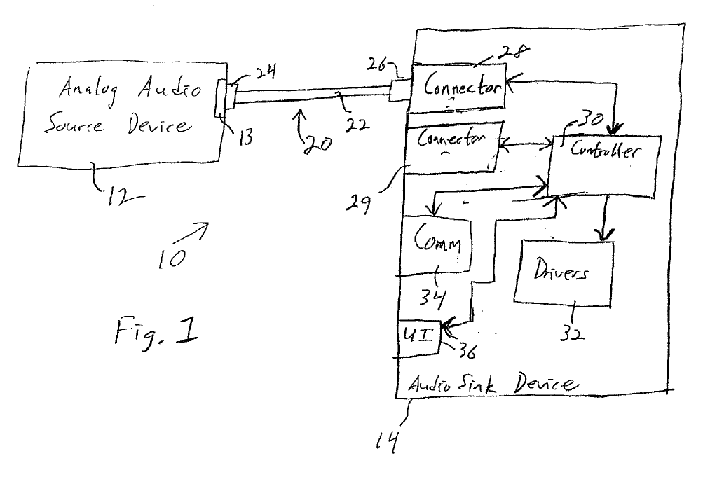

FIG. 1 is a schematic diagram of one non-limiting example of system 10 that is adapted to allow audio sink device 14 to receive audio signals from analog audio source device 12. Typically, but not necessarily, source 12 does not have wireless data transmission capabilities, but does have a hard-wired audio data output; a hard-wired data output is represented by connector 13, which may be a standard 3.5 mm stereo audio jack as only one non-limiting example. Audio sink device 14, which in non-limiting examples may be wireless headphones or a wireless loudspeaker, has hard-wired connector 28. Connector 28 may be a multiple-pin connector of a type known in the art. One non-limiting example is a USB connector, such as a USB-C connector, which is a 24-pin, fully reversible connector system that allows transport of data and energy. The connector pinouts and cable wiring of USB-C connectors are established by and published by the USB Implementers Forum and are well known in the field.

Electrical cable assembly 20 is coupled to both connector 13 and connector 28. Cable connectors 24 and 26 are designed to couple to the respective device connectors 13 and 28. Cable assembly 20 includes multiple-conductor electrical cable 22. Cable 22 has, at minimum, sufficient separate conductors to accomplish the functionalities described herein, and may have additional conductors as well, so as to allow for different or additional functionalities. A specific example is described below. In one non-limiting example, connector 24 is a standard analog audio connector, such as a 3.5 mm stereo audio plug. In one non-limiting example, connector 26 is a USB-C connector, e.g., a USB-C plug that fits into USB-C receptacle 28.

Audio sink device 14 comprises controller 30 that is operably coupled to connector 28, so that controller 30 can receive (or, at least have necessary effects on) electrical signals received over cable assembly 20. Device 14 also includes audio driver(s) 32, communications interface 34, and user interface (UI) 36. Other features of audio sink devices that are not involved in the present disclosure are not shown or described for the sake of convenience.

Audio sink device 14 is adapted to detect when cable assembly 20 has been operably coupled to device 14. In one non-limiting example, this detection is accomplished using controller 30. In this example, when controller 30 detects cable assembly 20, device 14 is enabled to conclude that an audio source is coupled to device 14 via cable assembly 20. Device 14 will then, via controller 30, be enabled to receive audio signals from source device 12 over cable assembly 20. Received audio signals can be played by drivers 32. Detection of when an analog audio source is connected to device 14 by cable assembly 20 may be accomplished in one non-limiting example by device 14 detecting that a configuration channel (CC) pin of a USB-C connector is shorted to ground. Detection could be accomplished by controller 30, for example.

Audio sink device 14 can also be enabled to detect when a source is not connected to it by cable assembly 20, in which case it can be enabled to accept audio data from another source (e.g., wirelessly via communication functionality 34). In instances in which device 14 is a wireless sink (e.g., wireless headphones), such other source will typically but not necessarily use a wireless transmission standard of a type well-known in the art to wirelessly transmit audio data to device 14 (e.g., Bluetooth, Bluetooth Low Energy (BLE), IEEE 802.11, or other local area network (LAN) or personal area network (PAN) protocols).

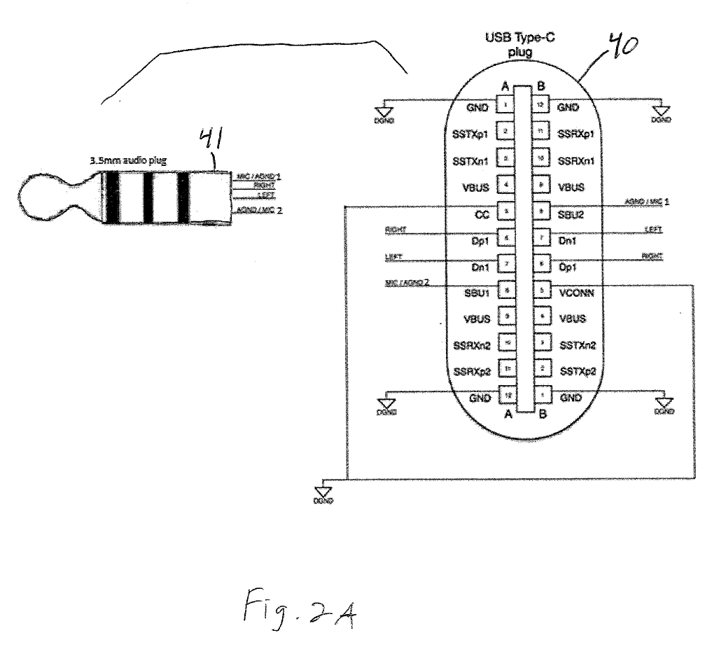

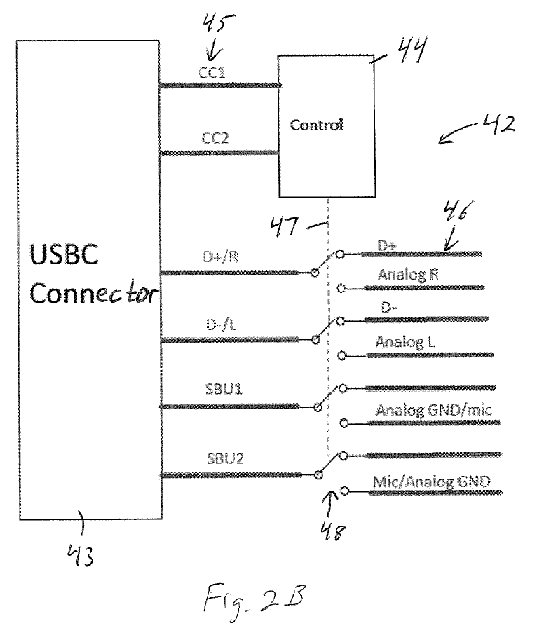

FIG. 2A illustrates a USB-C plug 40 and a 3.5 mm audio plug 41 for a cable that can be used to transfer analog audio data from an analog audio source with a 3.5 mm audio jack (e.g., an airplane entertainment system), to an audio sink device with a USB-C receptacle (e.g., wireless headphones or a wireless speaker package). The 24 pins of USB-C plug 40 are labelled per the well-known USB-C specification published by the USB Implementers Forum. FIG. 2B schematically illustrates a control scheme 42 in which a control aspect 44 of the audio sink device is operative to control the variable connections 48 (via control lines 47) between USB-C connector 43 pins 45 (see the USB-c pin specifications set forth in FIG. 2A) and the audio sink device internal circuit elements 46. The variable connections 48 are schematically depicted as switches that can be controlled to connect inputs 45 to one of two outputs comprising one of two of each pair of different circuit elements 46.

The analog source is detected in this non-limiting example by shorting the A5 and B5 pins (CC1 and CC2) directly in the USB-C analog cable. When the CC1 and CC2 pins are shorted to ground, the USB-C analog adapter is detected. D+/R, D−/L, SBU1, and SBU2 in the USB-C receptacle in the audio sink are switched to analog R, analog L, analog GND, and mic signal in the sink. Otherwise, the D+/R, D−/L are connected to D+, D− in the system for USB communication (by default), in which case the SBU1 and SBU2 are not connected to any signals. 3.5 mm plug 41 (FIG. 2A) is a TRRS plug that supports analog audio R, analog audio L, Mic/AGND1, and AGND2/Mic connections. One implementation of the connections to USB-C plug 40 is depicted in FIGS. 2A and 2B. If the cable does not have a mic, one of the Mic/AGND connections is not needed and the plug can have one less ring.

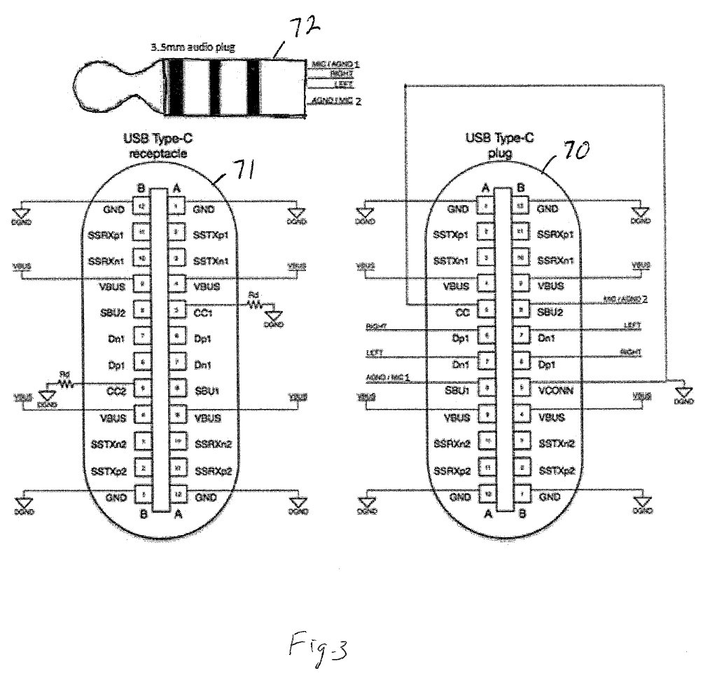

FIG. 3 is similar to FIG. 2A, but with an extra USB-C receptacle 71 for charging. Plug 72 in this example is the same as plug 41, FIG. 2A. CC and VCONN in the USB-C plug 70 are shorted to ground, so when the cable is plugged into a USB-C receptacle in the sink (e.g., headphone), it can indicate itself as an analog connection, so the headphone is adapted to receive analog audio from an audio source which is connected to the 3.5 mm jack. Meantime, in the USB-C receptacle 71, CC1 and CC2 are pulled down to GND with Rd resistor to indicate itself as a power sink, so when a power source with a USB-C plug is mated with this receptacle, 5V 500 mA power is allowed to be sent to the Vbus in the receptacle, which is also the VBus in the USBC plug. In this use case, the headphone can sink audio from the 3.5 mm plug and get charged from the USBC receptacle at the same time.

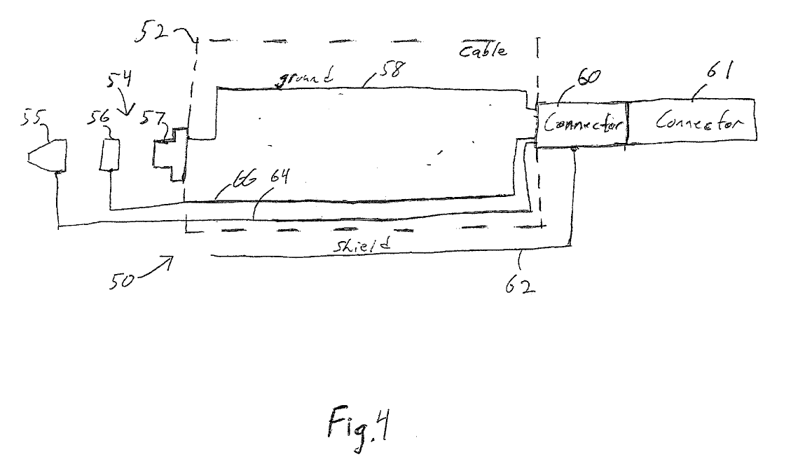

FIG. 4 schematically depicts a non-limiting example of a cable assembly 50 of the present disclosure, which may correspond to cable assembly 20 of FIG. 1. Cable assembly 50 comprises multi-conductor cable 52 with physical connectors 54 and 60 electrically coupled to conductors. In one non-limiting example, connector 54 is a standard 3.5 mm stereo audio plug connector with conductor 55, conductor 56, and conductor 57. The configuration of audio connectors is well known. Left and right analog audio signals are inputted to two of these three conductors, while the third is used for ground. In this non-limiting example, the left audio is provided to conductor 55 and its connected wire (or wire set) 64, and the right audio is provided to conductor 56 and its connected wire (or wire set) 66, while conductor 57 is the ground terminal and is connected to grounding conductor 58. Wires/wire sets 64 and 66 are connected to pins of connector 60. In one non-limiting example, connector 60 is a multi-contact/pin connector, such as a USB-C connector (e.g., a USB-C plug). The audio sink (not shown fully in FIG. 4) includes multi-contact/pin connector 61 (e.g., a USB-C receptacle) to which cable connector 60 is electrically coupled in a known manner. Cable assembly 50 is operable to transmit audio signals from an analog audio source to an audio sink, as described above.

In one non-limiting example, cable 52 may comprise a USB-C cable, with the conductors and functionality described in the USB-C standard, including but not limited to the USB communications standard. Standard pins on a USB-C connector include supply, ground and standard data lines that enable high data transfer rates. These are pins that are typically used for data transmission. In addition, the USB-C connector includes pins that are not normally utilized with a wireless headphone or wireless speaker, including the Rx1+, Rx1−, Tx1+, Tx1−, CC1, CC2, SBU1, and SBU2 pins. The Rx and Tx pins are typically connected to differential wire pairs that are used for higher speed data transmission. CC1 and CC2 are used for indicating that the cable will be used to provide analog signals through the sink's USB-C connector. D+, D−, SBU1, and SUB2 can be used to carry the left audio, right audio, and analog ground signals to the sink, respectively (i.e., they may comprise conductors 64, 66, and 58).

One example of the use of cable assembly 50 is to operably connect an in-flight entertainment system (which usually has only a 3.5 mm output jack), to wireless headphones or other wireless audio devices. A cable assembly with the connectors and signal-carrying functionalities described herein can be used to operably connect the headphones via a USB-C connector on the headphones. Examples of the connections accomplished by the cable (with a 3.5 mm analog audio plug at one end and a USB-C plug at the other end, and conductors that electrically interconnect the two connectors so as to accomplish the connections illustrated in the drawings) are illustrated in FIGS. 2A, 2B, and 3.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

What is claimed is:

1. A method of transferring analog audio signals from an analog audio source to an audio sink, where the audio sink has a USB-C connector, the method comprising:
coupling a cable to the audio source and to the USB-C connector of the audio sink, where the cable is constructed and arranged to carry audio signals;
detecting, by the audio sink, the coupling of the cable to the USB-C connector of the audio sink; and
responsive to the detecting, receiving, by the audio sink from the audio source over the cable, analog audio signals.

2. The method of claim 1, wherein the cable comprises a plug that is constructed and arranged to couple to an audio output jack of the audio source, and a USB-C plug that is constructed and arranged to couple to a USB-C receptacle of the audio sink.

3. The method of claim 2, wherein the plug that is constructed and arranged to couple to an audio output jack of the audio source comprises a 3.5 mm audio plug.

4. A system for receiving, by an audio sink, audio signals from an analog audio source, the system comprising:
a cable that is constructed and arranged to carry audio signals, and that comprises a first connector that is constructed and arranged to be coupled to an audio output of the audio source, and a second USB-C connector that is constructed and arranged to be coupled to a USB-C audio input of the audio sink; and
circuitry of the audio sink that is adapted to detect the coupling of the cable to the USB-C connector of the audio sink, and in response cause the reception of analog audio signals by the audio sink from the audio source over the cable.

5. The system of claim 4, wherein the cable comprises a plug that is constructed and arranged to couple to an audio output jack of the audio source, and a USB-C plug that is constructed and arranged to couple to a USB-C receptacle of the audio sink.

6. The system of claim 5, wherein the plug that is constructed and arranged to couple to an audio output jack of the audio source comprises a 3.5 mm audio plug.

7. The system of claim 4, wherein the cable is configured to short two connector pins of the second USB-C connector to ground.

8. The system of claim 7, wherein the two connector pins of the second USB-C connector comprise CC1 and CC2 pins.

9. The system of claim 7, wherein the shorting of the two connector pins of the second USB-C connector to ground is accomplished by the circuitry of the audio sink.

10. The system of claim 7, wherein when the two connector pins of the second USB-C connector are shorted to ground, a D+/R pin of the second USB-C connector is switched to analog R.

11. The system of claim 7, wherein when the two connector pins of the second USB-C connector are shorted to ground, a D−/L pin of the second USB-C connector is switched to analog L.

12. The system of claim 7, wherein when the two connector pins of the second USB-C connector are shorted to ground, an SBU pin of the second USB-C connector is switched to ground.

13. A cable, comprising:
a first connector that is constructed and arranged to be coupled to an audio output of an analog audio source;
a USB-C connector that is constructed and arranged to be coupled to a USB-C input connector of an audio sink, where the USB-C connector comprises a plurality of pins; and
a set of conductors that are electrically connected to both the first connector and the USB-C connector and are constructed and arranged to short two pins of the USB-C connector to ground, and to carry audio signals.

14. The cable of claim 13, wherein the first connector comprises a plug that is constructed and arranged to couple to an audio output jack of the audio source, and the USB-C connector comprises a USB-C plug that is constructed and arranged to couple to a USB-C receptacle of the audio sink.

15. The cable of claim 14, wherein the plug that is constructed and arranged to couple to an audio output jack of the audio source comprises a 3.5 mm audio plug.
